(19) United States
(12) Patent Application Publication
(10) Pub. No.: US 2004/0207718 A1
(43) Pub. Date: Oct. 21, 2004

(54) Camera positioning system and method for eye -to-eye communication

(76) Inventors: James H. Boyden, Seattle, WA (US); Kory D. Christensen, Kaysville, UT (US); David W. Meibos, Sandy, UT (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(21) Appl. No.: 09/992,567

(22) Filed: Nov. 14, 2001

(51) Int. Cl. H04N 7/14

(52) U.S. Cl. 348/14.01; 348/14.07

(57) ABSTRACT

Eye-to-eye videoconferencing may be carried out through the use of a flexible coupling that removably disposes a camera between a screen portion of a display and a person viewing the screen portion. The camera may be attached to a camera portion of the flexible coupling, and a fixation portion of the flexible coupling may be secured to the display. According to one example, the flexible coupling is an elastic or inelastic flexible loop that encircles the display. According to another example, the flexible coupling is a flexible line suspended from a base attached to a top side of the display.

### BACKGROUND

1. Field of the Invention

The present invention relates generally to the field of video communication. More specifically, the present invention relates to a system and method for positioning a camera to enable eye-to-eye videoconferencing.

2. Description of Related Background Art

Videoconferencing is rapidly becoming a popular method of communication between remote parties who wish to approximate face-to-face contact without travel. As bandwidth limitations are ameliorated, more events such as business meetings, family discussions, and shopping may be expected to take place through videoconferencing.

Unfortunately, videoconferencing has been limited in the past by the relative positions of the camera, the display, and the person. More specifically, the camera is typically positioned above, beside, or below the screen. As a result, a person looking into the screen appears to be looking above, below, or to the side of the person with whom they are speaking. Eye contact is never actually made because neither party looks at the camera; rather, each person looks at his or her own screen. Consequently, both parties perceive that true face-to-face communication is not occurring.

A lack of eye contact has a definite psychological impact. More specifically, if eye contact is not made, each party may misinterpret comments made by the other party; misunderstandings and mutual distrust may result. The communicating parties may find themselves unable to adequately understand each other, and may even prematurely terminate the videoconferencing session out of frustration. Hence, poor quality communications are not only problematic for the communicating parties, but also for the entity that provides the communication channel. To the extent that access to the channel is metered, longer videoconferencing sessions will provide greater profits.

Some devices have been made in an attempt to more closely simulate eye-to-eye communication. Such devices may involve, for example, the use of complex and specialized displays with advanced optical and projection equipment. Unfortunately, most consumers would wish to communicate via conventional, inexpensive personal computer or entertainment hardware such as “webcams” and televisions.

Accordingly, what is needed is a system and method for obtaining an image of a person from along the person's eye level when the person is looking at the image of a second person on a screen. Preferably, such a system should lend the impression of eye-to-eye communication without unduly burdening other aspects of the videoconferencing process or distracting the communicating party with camera attachments that move excessively or obstruct the screen more than necessary. Additionally, such a system and method should preferably be adaptable to existing consumer hardware.

### BRIEF DESCRIPTION OF THE DRAWINGS

Non-exhaustive embodiments of the invention are described with reference to the figures, in which:

FIG. 1 is a perspective view of one embodiment of an apparatus for obtaining a video signal from a position proximate an eye level of a person viewing a display;

FIG. 2 is a partial, exploded, perspective view of a camera attachment suitable for the apparatus of FIG. 1;

FIG. 3 is a perspective view of a back side of the display of FIG. 1, showing a display attachment suitable for the apparatus of FIG. 1;

FIG. 4 is a perspective view of an alternative embodiment of an apparatus for obtaining a video signal from another position proximate an eye level of a person viewing a display;

FIG. 5 is a perspective view of another alternative embodiment of an apparatus for obtaining a video signal from yet another position proximate an eye level of a person viewing a display; and

FIG. 6 is a partial, exploded, perspective view of an attachment mechanism suitable for securing the base of FIG. 5 to the top side of the display.

### DETAILED DESCRIPTION OF THE PREFERRED EMBODIMENTS

The present invention solves the foregoing problems and disadvantages by providing an apparatus for obtaining a video signal from a position proximate an eye level of a person viewing a display. In conjunction with the apparatus, a method for positioning the camera is also provided. The apparatus and method may be configured in a wide variety of ways to suit specific videoconferencing situations.

In one implementation, the apparatus may include a camera and a flexible coupling with a camera portion and a fixation portion. The flexible coupling may be selectively disposed such that the camera portion is positioned alongside a screen portion of the display. A camera may be disposed at a camera portion of the flexible coupling such that the camera is positioned between the viewer and the screen portion. The viewer may thus use the flexible coupling to move the camera to an eye level position, in which the camera is close to the level at which the viewer looks at the display. Similarly, the flexible coupling may be used to move the camera to a retracted position to avoid obscuring the display during normal use.

Of course, the actual location of the camera will vary depending on the viewer. For some viewers, moving the camera to an eye level position will require the camera to be positioned at the center of the display. For other viewers, however, the camera may need to be positioned in other areas of the display.

The flexible coupling may be a flexible loop. In one embodiment, the flexible loop is elastic, and has an unstretched configuration in which the flexible loop is not sufficiently long to encircle the display, and a stretched configuration in which the flexible loop encircles the display. The flexible loop may be stretched such that the camera portion is disposed over the screen portion of the display. The camera may be permanently or removably attached to the camera portion through the use of a camera attachment, which may include mechanical fastening systems, adhesives, and the like.

The flexible loop then grips the display to keep itself in place. If desired, a display attachment may be utilized to keep the fixation portion secured to the display to ensure that the flexible loop does not slide out of engagement with the display. The display attachment may include mechanical fastening systems, adhesives, and the like.

The flexible loop may also be made from a non-stretchable material. The flexible loop may then be tightened around the display through the use of an adjustment mechanism such as a buckle, tensioner, or the like. The flexible loop may have a stretchable, opaque portion and a non-stretchable, transparent portion, to which the camera is attached. The transparent portion may then pass in front of the screen portion of the display, thereby minimizing obstruction of the screen portion.

In another embodiment, the flexible coupling may take the form of a flexible line with the fixation portion disposed proximate a top side of the display screen such that the camera portion hangs downward alongside the screen portion. The fixation portion may be gripped by a base resting on the top side. The base may have a retraction mechanism that selectively retracts the flexible line to draw the camera upward into a retracted position, in which the screen portion is not impeded by the camera.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of translational couplings, attachment devices, camera positions, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

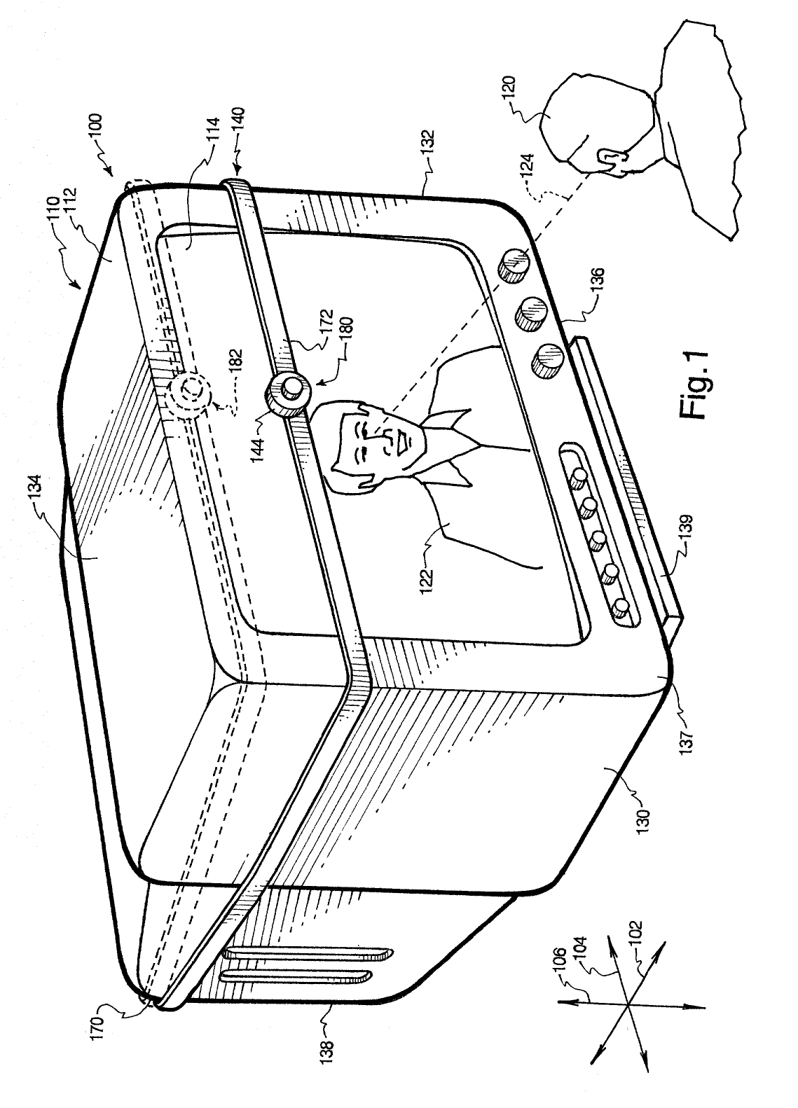

Referring to FIG. 1, a perspective view shows one embodiment of an apparatus 100 for obtaining a video signal from a position proximate an eye level of a person viewing a display. The apparatus 100 may have a longitudinal direction 102, a lateral direction 104, and a transverse direction 106.

A display 110 may be of any known type, such as a cathode ray tube (CRT) screen, a liquid crystal display (LCD), liquid plasma display, analog or digital projection, or the like. Advantageously, the display 110 may be a device commonly available to consumers, such as a computer monitor or television. The display 110 may have a housing 112 that contains the internal components of the display, and a screen portion 114 on which images are displayed.

The display 110 may be used by a person 120 to conduct videoconferencing with a second person, whose image 122 is shown on the screen portion 114 of the display 110. The person 120 may be expected to look at the image 122, so that the person 120 is looking along an eye level 124, as shown by a dashed line in FIG. 1. The person 120 may, for example, look approximately at the eyes of the person whose image 122 is shown on the screen portion 114.

The display 110 may have a left side 130, a right side 132, a top side 134, a bottom side 136, a front side 137, and a back side 138. Furthermore, the display 110 may have a base 139 that supports the weight of the display 110. The base 139 may be rigid, or may permit swiveling or tilting of the display 110. Of course, the display 110 may also operate without a base 139.

The apparatus 100 of FIG. 1 has a flexible coupling, which may take the form of a flexible loop 140, or loop 140. The flexible loop 140 may be formed of an elastic material, such as an elastomer, flexible polymer, or stretching fabric. The loop 140 may be of such a length (i.e., circumference) that the loop 140 is able to encircle the display 110 only when the loop 140 is stretched somewhat. The loop 140 may encircle the display horizontally, as shown, or may be disposed vertically or at an oblique angle.

The loop 140 may be used to dispose a camera 144 at a position comparatively close to the eye level 124 of the person 120. If desired, the camera 144 may be a wireless camera that transmits video data to a receiver unit (not shown) through any suitable protocol, such as IEEE 802.11, IEEE 802.11a, IEEE 802.11b, Bluetooth, HiperLan, and HiperLan/2. The camera 144 may also transmit an analog video signal, for example, through frequency or amplitude modulation of radio waves. If desired, the camera 144 may be configured in a manner similar to the XCam2™ wireless camera manufactured by X10 Wireless Technologies, Inc. of Seattle, Wash. The camera 144 may have an internal power source such as one or more batteries.

In the alternative, the camera 144 need not be wireless. Rather, the camera 144 may be connected to a receiver unit (not shown) or telecommunications network (not shown) through the use of wiring (not shown). Such wiring may simply extend from the camera 144. In the alternative, wiring from the camera 144 may be disposed along the loop 140, and may then extend from some part of the loop 140 to the receiver unit or telecommunications network.

If desired, the camera 144 may have adjustable pan and/or tilt settings, so that during videoconferencing the person 120 need not have his or her head directly aligned with the camera 144 in the lateral direction 104 or the transverse direction 106. The person 120 may also use such pan and/or tilt settings to utilize the camera 144 for videoconferencing when the camera 144 is positioned off the screen portion 114.

Additionally, the camera 144 may have features that automatically deactivate the camera 144 when the camera 144 is removed from the screen portion 114 to protect the privacy of the person 120. For example, the camera 144 may have a mechanical switch, proximity sensor, light sensor, or the like (not shown) abutting the screen portion 114. When the camera 144 is removed from the screen portion 114, the switch or sensor may stop the camera 144 from transmitting video data.

If desired, the camera 144 may include one or more light emitting diodes (LED's) that provide a visual indication of whether the camera 144 is operating. Alternatively, the camera 144 may be equipped with a mechanical shutter that can be manually closed or actuated through the use of a switch or sensor to assure the person 120 that the camera 144 is not receiving any image.

Furthermore, if desired, the camera 144 may have an optical sensor (not shown) facing the screen portion 114 to enable the person 120 to control the camera 144. For example, through the use of specialized software, hardware, or firmware, commands to control functions such as panning, tilting, zooming, contrast adjustment, and brightness adjustment could be translated into patterns of flashes, color changes, or the like. The patterns may be displayed on the portion of the screen portion 114 behind the camera 144. The patterns may be read by the sensor of the camera 144, and the camera 144 may then adjust its operation to carry out the user command.

The loop 140 may advantageously be made as thin as possible in the transverse direction 106 to avoid obscuring the image 122 any more than necessary. For example, the loop 140 may be only a centimeter thick in the transverse direction 106, or less. For ease of illustration, the loop 140 is depicted in FIG. 1 as being thicker, perhaps a centimeter or more. Of course, the precise thickness of the loop 140 is not crucial to the invention.

The loop 140 may also be made transparent, if desired, to further reduce obstruction of the screen portion 114. Furthermore, the loop 140 may be made partially transparent and partially opaque. For example, the portion of the loop 140 that passes behind the display 110 may be opaque and stretchable. The portion of the loop 140 that covers the screen portion 114 may be made non-stretchable and transparent. A clear, flexible plastic strip may simply be sewn, bonded, or otherwise attached to an elastic strip at both ends to form the loop 140.

Thus, the loop 140 retains its resilience without unduly occluding the screen portion 114. For purposes of this application, the term “transparent” does not require perfect passage of light through the transparent object, but rather sufficient light transmission that an image on a screen can be clearly viewed through the transparent object.

Thus, the loop 140 may have a fixation portion 170 secured to the display 110 and a camera portion 172 disposed adjacent to the screen portion 114. The camera 144 is located at the camera portion 172. The fixation portion 170 is shown adjacent to the back side 138 of the display 110. However, the fixation portion 170 may be located along any portion of the loop 140 that contacts the display 110, either directly or indirectly. The fixation portion 170 may be secured to the display 110 through simple friction, or through the use of separate attachment hardware.

If desired, the camera 144 may be movable in the lateral direction 104 along the camera portion 172, for example, through the use of some form of removable attachment. In the alternative, the camera 144 may be disposed on a slider (not shown) that slides or rolls along the loop 140. The camera portion 172 may have a substantial length, and may even include the entire length of the loop 140 that passes adjacent to the screen portion 114. As another alternative, the loop 140 may simply be jogged by hand to move the camera 144 in the lateral direction 104.

The person 120 may use the apparatus 100 to position the camera 144 at an eye level position 180, which may be positioned proximate the eyes of the image 122 on the screen portion 114. When the display 110 is in use for purposes other than videoconferencing, such as computer or television use, the camera 144 may be moved to a retracted position 182 in which the camera 144 and the loop 140 do not significantly overlap the screen portion 114. In FIG. 1, the retracted position 182 is shown over the top of the screen portion 114. The camera 144 could also be moved to many other positions to avoid obstructing use of the display 110.

Displacing the camera 144 slightly from the eyes of the image 122 provides the realistic semblance of eye-to-eye communication for the person whose image 122 is displayed on the screen portion 114, i.e., the person with whom the person 120 using the apparatus 100 is communicating. For example, the camera 144 may be disposed slightly above and/or to one side of the head of the image 122, as shown in FIG. 1. In alternate embodiments, the camera 144 may be disposed slightly below or simply to the left or right of the head of the image 122.

Thus, the camera 144 need not be disposed precisely along the eye level 124. If the camera 144 is simply positioned proximate, or close to, the eye level 124, the person whose image 122 is shown on the screen portion 114 may not notice that the person 120 is looking slightly up or down, or to one side. Thus, if both parties involved in videoconferencing are using an apparatus 100, slight displacement of the cameras 144 from eye level 124 may provide realistic eye-to-eye communication for both parties simultaneously.

However, in accordance with the present invention, the camera 144 may be positioned precisely along the eye level 124 so that, depending on the geometry of the camera 144 and the loop 140, the eyes of the person whose image 122 is displayed may be blocked by the camera 144 and the loop 140.

Clearly, the camera 144 need not be disposed in the center of the screen portion 114. For the reasons described above, it may be desirable to position the camera 144 off-center. Furthermore, the image 122 may not be centered, but may be within a window with any size or location on the screen portion 114. Hence, motion of the camera 144 in the lateral 104 and transverse directions 106 may be desirable so that the position of the camera 144 can be adapted to suit the size and position of the image 122.

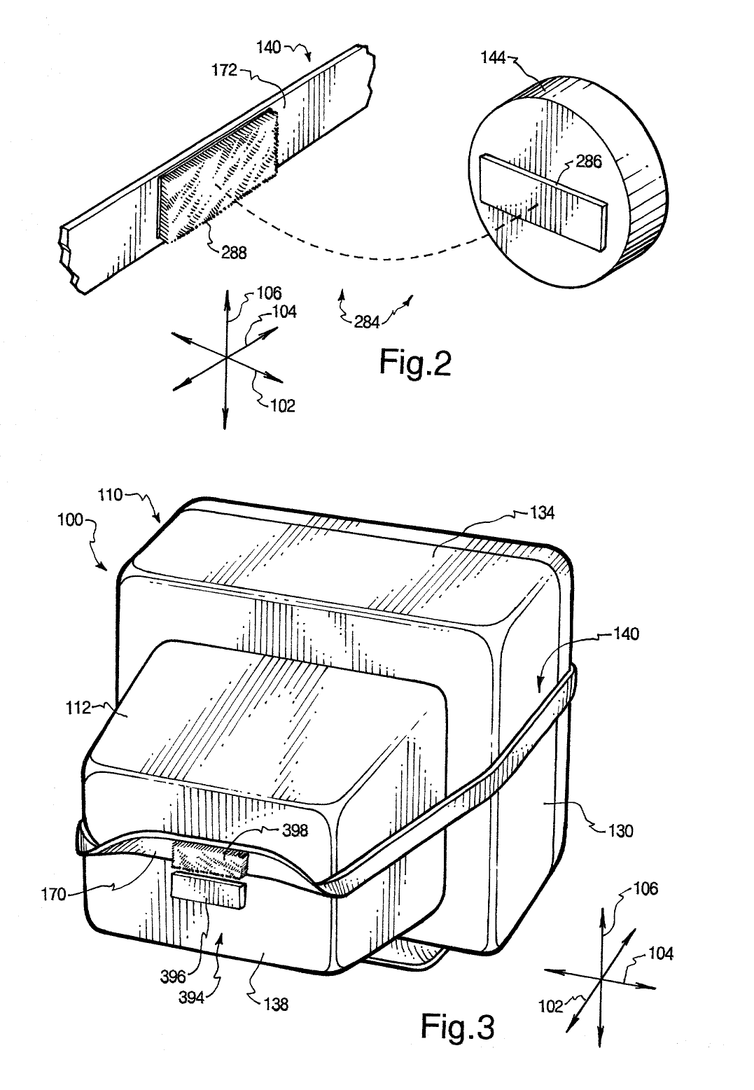

Referring to FIG. 2, a perspective view is shown of a section of the camera portion 172 of the loop 140 with the camera 144 detached. The camera 144 may be removably attached to the camera portion 172 to permit easy storage of the apparatus 100 or movement of the camera 144 along the camera portion 172. A camera attachment 284 may be used to provide removable attachment.

The camera attachment 284 may take a variety of forms, including fastening systems, adhesives, and the like. For example, glue, tape, clips, clamps, or the like may be used to removably attach the camera 144 to the camera portion 172. Alternatively, the camera 144 may be permanently attached to the camera portion 172, for example, by providing a closed slot (not shown) in the camera 144 through which the camera portion 172 extends.

As shown in FIG. 2, the camera attachment 284 takes the form of a hook and loop fastening system (e.g., Velcro®). The camera attachment 284 may thus have a first portion 286 attached to the camera 144 and a second portion 288 attached to the loop 140. The first portion 286 may have protruding, flexible hooks, and the second portion 288 may have loops that mate with the hooks. The first and second portions 286, 288 may be removably attached to the camera 144 and the camera portion 172, respectively, through the use of an adhesive.

In the alternative, the second portion 288 may be integrally formed with the loop 140, and may extend entirely around the circumference of the loop 140. The camera 144 may then be moved in the lateral direction 104 by simply detaching the camera 144 from the second portion 288 and re-attaching the camera 144 at a different part of the second portion 288. Such a method may even be used to stow the camera 144 when the camera 144 is not in use; the camera 144 may be attached to the loop 140 adjacent to the left, right, or back sides 130, 132, 138, or even to the front side 137 to one side of the screen portion 114. An elongated second portion 288 may also be provided separately and attached to the loop 140 to accomplish the same purpose.

Referring to FIG. 3, a perspective view is shown of the back side 138 of the display 110, with the loop 140 twisted to more clearly show the fixation portion 170. The function of the fixation portion 170 is to press against the display 110 in such a manner that the camera portion 172 is maintained at or near the eye level position 180 shown in FIG. 1. The fixation portion 170 need not be secured to the display 110 through the use of any external device; the tension created by stretching the loop 140 may be sufficient to secure the fixation portion 170 to the back side 138 in a frictional manner.

Nevertheless, pure frictional attachment may permit the fixation portion 170 to slide along the back side 138, thereby permitting undesired motion of the camera portion 172. Thus, a display attachment 394 may be used to ensure that the fixation portion 170 remains properly positioned against the back side 138. Like the camera attachment 284, the display attachment 394 may be permanent or removable, and may include glue, tape, clips, clamps, or the like.

As shown in FIG. 3, the display attachment 394 takes the form of a hook and loop fastening system (e.g., Velcro®), like the camera attachment 284. The display attachment 394 may thus have a first portion 396 attached to the display 110 and a second portion 398 attached to the loop 140. The first and second portions 396, 398 may mate to secure the fixation portion 170 to the back side 138 in a manner that is more reliable than pure frictional attachment.

Of course, the display attachment 394 may also be positioned on the left, right, top, or bottom sides 130, 132, 134, 136 of the display 110. The display attachment 394 may even be positioned on the front side 137, above, below, or to the side of the screen portion 114. Multiple display attachments 394 may also be used.

The apparatus 100 may be sold as a kit that includes the loop 140, the camera 144, the camera attachment 284, and the display attachment 394. The person 120 may use the camera attachment 284 to attach the camera 144 to the loop 140. The person 120 may then stretch the loop 140 to position the loop 140 around an existing display 110 such as a television, computer monitor, or the like. Then, the person 120 may use the display attachment 394 to attach the fixation portion 170 to the back side 138. Such a kit may even include only the loop 140 and camera attachment 284; the kit may then be utilized to position an existing camera 144, such as a commonly available webcam, with respect to an existing display 110.

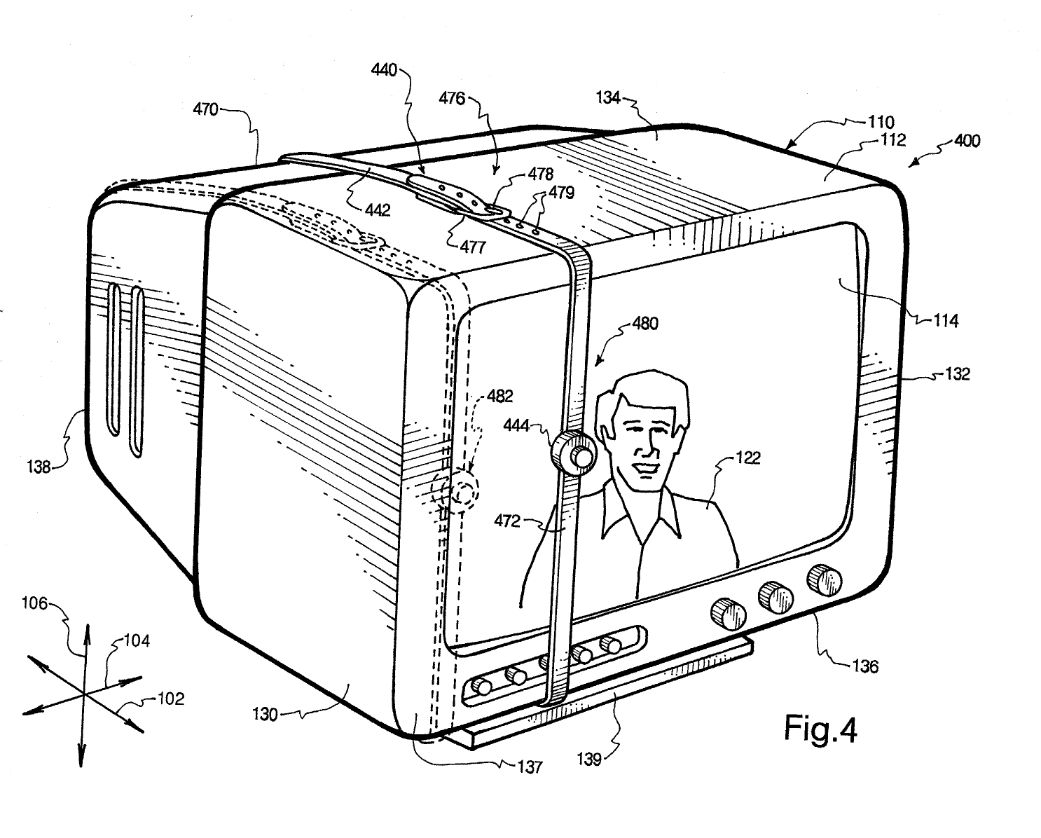

Referring to FIG. 4, an alternative embodiment is shown of an apparatus 400 for obtaining a video signal from a position proximate an eye level of a person viewing a display 110. The apparatus 400 has a flexible loop 440, or loop 440 with a length sufficient to encircle the display 110. In FIG. 4, the loop 440 is shown encircling the display 110 vertically; however, the loop 440 may also be disposed horizontally, as shown in FIG. 1, or at an oblique angle.

The loop 440 of FIG. 4 may include a strap 442 with a substantially unstretchable configuration; the strap 442 may be constructed of a non-stretching fabric or the like. The strap 442 may be used to position a camera 444 close to the eyes of the image 122 in a manner similar to the loop 140 of FIG. 1. The loop 440, or more specifically, the strap 442, may have a fixation portion 470 and a camera portion 472. As with the previous embodiment, the camera 444 is disposed at the camera portion 472, and the fixation portion 470 engages the display 110 to keep the camera portion 472 in the desired position. The fixation portion 470 may abut the back side 138 of the display 110.

In addition to the strap 442, the loop 440 may have an adjustment mechanism 476 that can be used to control the circumference of the strap 442. More specifically, the strap 442 may have two unconnected ends, and the adjustment mechanism 476 may be used to control the point at which the strap 442 is attached to itself to form the loop 440.

The adjustment mechanism 476 may take a variety of forms, such as tensioning devices, buckles, clasps, clips, clamps, and the like. As shown in FIG. 4, the adjustment mechanism 476 may have a buckle 477 with a protruding, pivotable pin 478 that can be inserted into one of a plurality of holes 479 formed in the strap 442.

A user may secure the loop 440 to the display 110 by, first, using the adjustment mechanism 476 to increase the size of the loop 440. The user may then slide the loop 440 around the display 110 such that the camera portion 472 is properly positioned. The user may then utilize the adjustment mechanism 476 to tighten the loop 440 such that the loop 440 frictionally engages the display 110.

As with the previous embodiment, a camera attachment (not shown) may be used to removably or permanently attach the camera 444 to the strap 442. Additionally, a display attachment (not shown) may be used to more securely attach the strap 442 to the display 110.

The apparatus 400 may have an eye level position 480, in which the camera 444 is disposed near the eye level of a viewer. Additionally, the apparatus 400 may have a retracted position 482 in which the camera 444 is offset from the screen portion 114 to avoid obstructing viewing. As shown, the retracted position 482 may be to the left of the screen portion 114. As above, other implements may be used to reassure the user that the camera 444 is inoperative when in the retracted position 482.

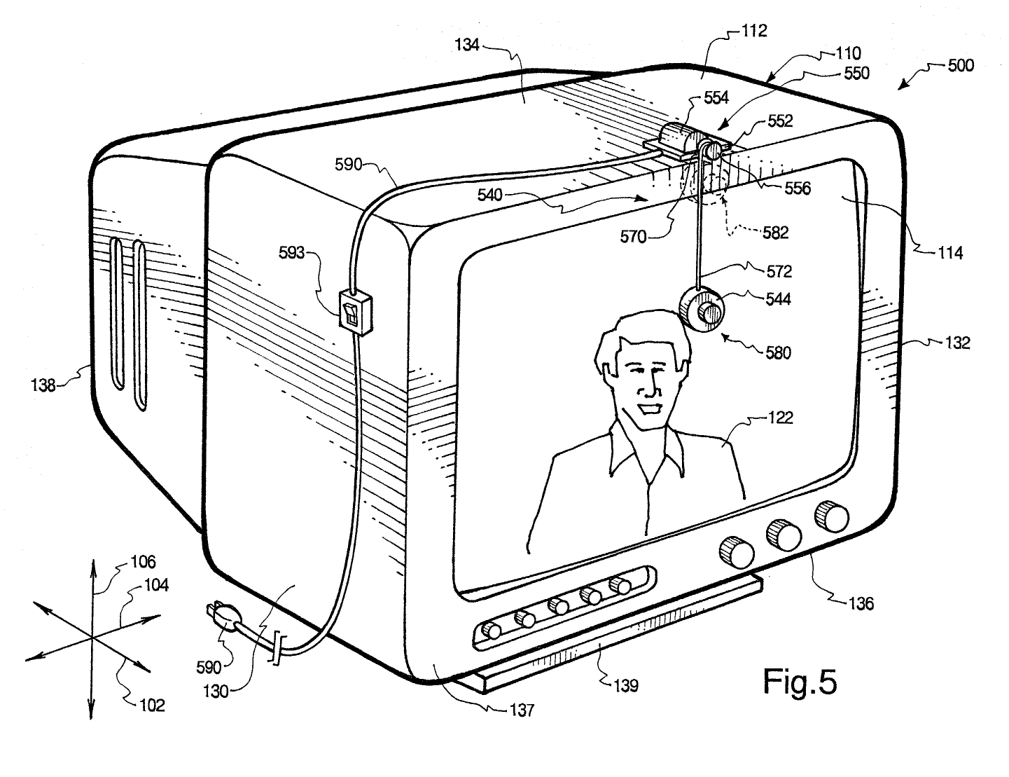

In the apparatus 400 of FIG. 4, the person 120 manually, i.e., by hand, adjusts the position of the camera 444. However, in certain embodiments, adjustment of the location of the camera 444 may be mechanized, and may even occur automatically. FIG. 5 presents an embodiment in which mechanized adjustment occurs.

Referring to FIG. 5, another alternative embodiment shows an apparatus 500 for obtaining a video signal from a position proximate an eye level of a person viewing a display. The apparatus 500 may have a flexible coupling that takes the form of a flexible line 540, or line 540, which is distinguished from a loop in that the ends of the line 540 are not connected. The line 540 may be a strap with a rectangular cross section, or may take the form of a thinner member such as a thread, cord, or cable. The line 540 may be used to suspend the camera 544 from the top side 134 of the display 110, alongside the screen portion 114, near the eyes of the image 122.

More specifically, the apparatus 500 may have a base 550 that rests on the top side 134 of the display 110. The base 550 may have a platform 552 with a generally flat shape. A motor 554 may be attached to the platform 552. The motor 554 may take the form of a conventional electric rotary motor. A pulley 556 may be coupled to the motor 554 such that the motor 554 rotates the pulley 556.

The flexible line 540 may have a fixation portion 570 attached to the pulley 556 and a camera portion 572 hanging alongside the screen portion 114. The camera 544 may be attached to the camera portion 572 through the use of a camera attachment (not shown). The camera attachment may be any of the types listed above. If desired, the camera 544 may be permanently attached to the camera portion 572. As above, the camera 544 may be wireless, or in the alternative, may transmit video data through a cord (not shown) that travels along the line 540 to a receiver unit (not shown) or telecommunications system (not shown).

The motor 554 and the pulley 556 may be used to move the camera 544 between an eye level position 580 and a retracted position 582. In the eye level position 580, the camera 544 may hang alongside the screen portion 114, between the screen portion 114 and the person 120. In the retracted position 582, the camera 544 may be disposed over the screen portion 114 to avoid obstructing the user's view of the screen portion 114. As with previous embodiments, various implements may be used to ensure that the camera 544 receives no image when in the retracted position 582.

As with previous embodiments, the eye level position 580 need not be precisely at the eye level 124, and need not be centered with respect to the screen portion 114. Additionally, the retracted position 582 need not be as shown, but may be any suitable position. If desired, the base 550 may be slidable along the top side 134 of the display 110, or the pulley 556 may be slidable along the base 550, to enable motion of the camera 544 in the lateral direction 104. Furthermore, multiple pulleys and flexible lines may be coupled to the camera 544 to enhance the stability of the camera 544.

The motor 554 may be connected to a power cord 590, through which electricity is delivered to the motor 554 from an electric plug 592. The electric plug 592 may be designed for use with an ordinary household electrical outlet. The motor 554 may be designed to rotate at a speed selected to provide rapid, and yet controllable, retraction and deployment of the camera 544.

The power cord 590 may be connected to the electric plug 592 via a switch 593, so that the person 120 can selectively activate the motor 554 by operating the switch 593. The switch 593 may be a three-way switch, so that the motors 554 can be deactivated, rotated to induce upward motion of the camera 544, or rotated to induce downward motion of the camera 544.

As an alternative or in addition to the switch 593, the motor 554 may be triggered through software, or even automatically activated upon the commencement of videoconferencing. Thus, the camera 544 may be automatically moved from the retracted position 582 to the eye level position 580 for eye-to-eye videoconferencing. Of course, the pulley 556 may also be activated by hand; in place of the motor 554, a hand crank or the like may be provided. A ratchet or a similar mechanism may then be used to keep the camera 544 at the desired height.

As another alternative, a spring (not shown), such as a torsional spring, may be used in place of the motor 554. The camera 544 may then be drawn downward by hand against the force of the spring; a ratchet or other latching mechanism may then be actuated by the user to grip the line 540 to keep the camera 554 in place. If desired, the line 540 may even extend downward past the camera 544 so that the lower end of the flexible line 540 can be attached to the bottom side 136 of the screen 110 to position the camera 544 at the eye level position 580. The camera 544 may then be moved to the retracted position 582 by unlatching the line 540 and allowing the spring to reel the line 540 upward.

As yet another alternative, the base 550 need not be provided. The fixation portion 570 of the line 540 may simply be attached directly to the top side 134 of the display 110 through the use of any of the attachment implements described previously. Retraction of the camera 544 into a retracted position may then be accomplished by simply placing the camera 544 on the top side 134, or even repositioning the camera 544 such that the camera 544 hangs alongside the left side 130, the right side 132, the back side 138, or the front side 137, to the left or right of the screen portion 114.

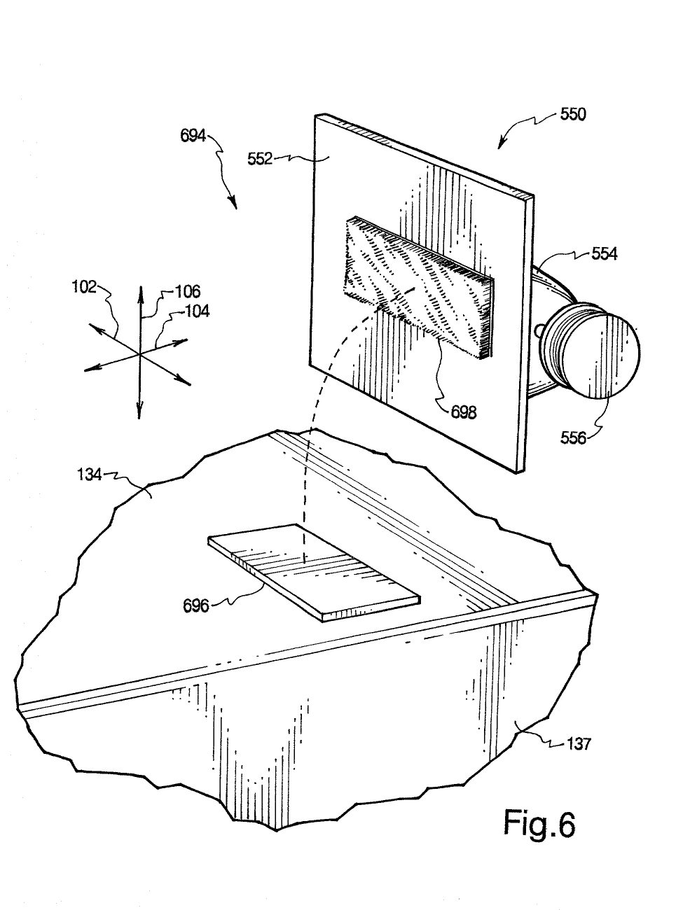

Referring to FIG. 6, the top side 134 of the display 110 is shown, with the base 550 detached. If desired, the base 550 may simply rest on the top side 134. In such a case, the base 550 may be weighted or otherwise stabilized to ensure that the base 550 does not slide off of the top side 134. Alternatively, the base 550 may be removably secured to the top side 134 through the use of a display attachment 694, as depicted in FIG. 6.

As with the attachment implements described previously, the display attachment 694 may include glue, tape, clips, clamps, and other fastening systems. As shown in FIG. 6, the display attachment 694 may take the form of a hook and loop fastening system (e.g., Velcro®). The display attachment 694 may thus have a first portion 696 attached to the top side 134 of the display 110 and a second portion 698 attached to the bottom of the platform 552. The first and second portions 696, 698 may be mated to removably secure the base 550 to the top side 134. Thus, the camera 544 may also be removed from the screen portion 114 by removing the base 550 entirely from the display 110.

In the alternative, the base 550 may be removably attached to the top side 134 through the use of fasteners such as screws, nuts, and bolts. Such fasteners may require the presence of a receiving aperture, mounting flange, or other attachment feature on the top side 134. Thus, if desired, a suction cup may be used so that the base 550 can be attached flat surfaces commonly present on commercially available displays. In such a case, the suction cup may simply be affixed to the underside of the base 550 so that the user can press the base 550 downward against the top side 134 to induce adhesion of the suction cup.

Based on the foregoing, the present invention offers a number of advantages that are not available in conventional approaches. A person can relatively easily retrofit an apparatus according to the invention to existing hardware such as a television or computer monitor. Furthermore, a person can relatively easily position the camera proximate their eye level or in a retracted position to avoid interfering with other uses of the display. Thus, during videoconferencing, a person can receive the impression that the person with whom they are communicating is looking them directly in the eye.

While specific embodiments and applications of the present invention have been illustrated and described, it is to be understood that the invention is not limited to the precise configuration and components disclosed herein. Various modifications, changes, and variations apparent to those skilled in the art may be made in the arrangement, operation, and details of the methods and systems of the present invention disclosed herein without departing from the spirit and scope of the invention.

What is claimed is:

1. An apparatus for obtaining a video signal from a position proximate an eye level of a person viewing a display, the apparatus comprising:
a flexible coupling having a camera portion and a fixation portion removably secured to the display to position the camera portion alongside a screen portion of the display;
a camera; and
a camera attachment to attach the camera to the camera portion such that the camera is positioned between the screen portion and the person.

2. The apparatus of claim 1, wherein the flexible coupling comprises a flexible loop having a length sufficient to encircle the display.

3. The apparatus of claim 2, wherein the flexible loop exerts inward pressure against the display such that the fixation portion frictionally engages the display.

4. The apparatus of claim 3, wherein the flexible loop is elastic, the flexible loop having an unstretched configuration in which the length is insufficient to encircle the display, and a stretched configuration in which the length is sufficient to encircle the display.

5. The apparatus of claim 3, further comprising an adjustment mechanism that selectively tightens the flexible loop around the display.

6. The apparatus of claim 1, wherein the flexible coupling comprises a flexible line, wherein the fixation portion is disposed proximate a top side of the display such that the flexible line hangs downward along the screen portion.

7. The apparatus of claim 6, further comprising a base resting on the top side to grip the fixation portion.

8. The apparatus of claim 7, wherein the base retractably grips the fixation portion such that the base is capable of retracting the camera into a retracted position in which the camera is not disposed alongside the screen portion.

9. An apparatus for obtaining a video signal from a position proximate an eye level of a person viewing a display, the apparatus comprising:
a flexible loop having a length sufficient to encircle the display, the flexible loop having a camera portion and a fixation portion that exerts pressure against the display to position the camera portion alongside a screen portion of the display;
a camera; and
a camera attachment that attaches the camera to the camera portion such that the camera is positioned between the screen portion and the person.

10. The apparatus of claim 9, wherein the flexible loop comprises an elastic band sized to grip the display such that the fixation portion abuts a back side of the display.

11. The apparatus of claim 9, wherein the flexible loop comprises:
a strap; and
an adjustment mechanism that engages the strap to tighten the strap around the display.

12. The apparatus of claim 9, wherein at least a portion of the flexible loop is transparent.

13. The apparatus of claim 9, wherein the camera attachment permits rapid, manual removal of the camera from the camera portion.

14. The apparatus of claim 13, wherein the camera attachment comprises a hook and loop fastening system with a first portion affixed to a back side of the camera and a second portion affixed to the camera portion.

15. The apparatus of claim 13, wherein the camera attachment comprises a clip disposed on a back side of the camera to selectively engage the camera portion.

16. The apparatus of claim 9, wherein the camera attachment comprises an adhesive disposed between a back side of the camera and the camera portion to permanently affix the camera to the camera portion.

17. The apparatus of claim 9, further comprising a display attachment that attaches the fixation portion to the display.

18. The apparatus of claim 17, wherein the display attachment comprises a hook and loop fastening system with a first portion attached to the display and a second portion attached to the fixation portion.

19. An apparatus for obtaining a video signal from a position proximate an eye level of a person viewing a display, the apparatus comprising:
a base resting on the display over a screen portion of the display;
a flexible line suspended from the base, the flexible line having a camera portion disposed alongside the screen portion and fixation portion attached to the base; and
a camera attached to the camera portion such that the camera is suspended from the flexible line and positioned between the screen portion and the person.

20. The apparatus of claim 19, wherein the base rests on a top side of the display in an unsecured manner.

21. The apparatus of claim 19, further comprising a display attachment that attaches the base to a top side of the display.

22. The apparatus of claim 21, wherein the display attachment comprises a hook and loop fastening system with a first portion affixed to the top side and a second portion affixed to the base.

23. The apparatus of claim 21, wherein the display attachment comprises a suction cup disposed on an underside of the base to selectively engage the top side.

24. The apparatus of claim 19, wherein the base comprises a retractor that selectively exerts tension on the fixation portion to retract the camera into a retracted position in which the camera is not disposed alongside the screen portion.

25. The apparatus of claim 24, wherein the retractor comprises a pulley around which the fixation portion is disposed, wherein the pulley is rotatable to draw the camera into the retracted position.

26. A method for obtaining a video signal from a position proximate an eye level of a person viewing a display, the apparatus comprising:
providing a flexible coupling having a camera portion and a fixation portion;
providing a camera;
attaching the camera to the camera portion with a camera attachment; and
securing the fixation portion to the display such that the camera portion is suspended alongside a screen portion of the display, between the screen portion and the person.

27. The method of claim 26, wherein providing the flexible coupling comprises providing a flexible loop having a length sufficient to encircle the display.

28. The method of claim 27, wherein securing the fixation portion to the display comprises disposing the flexible loop to exert inward pressure against the display such that the fixation portion frictionally engages the display.

29. The method of claim 28, wherein the flexible loop is elastic, the flexible loop having an unstretched configuration in which the length is insufficient to encircle the display, and a stretched configuration in which the length is sufficient to encircle the display.

30. The method of claim 28, further comprising:
providing an adjustment mechanism that selectively tightens the flexible loop around the display.

31. The method of claim 26, wherein providing the flexible coupling comprises providing a flexible line, and wherein securing the fixation portion to the display comprises disposing the fixation portion proximate a top side of the display such that the flexible line hangs downward along the screen portion.

32. The method of claim 31, further comprising:
providing a base; and
disposing the base to rest on the top side to grip the fixation portion.

33. The method of claim 32, wherein the base retractably grips the fixation portion such that the base is capable of retracting the camera into a retracted position in which the camera is not disposed alongside the screen portion.

34. An apparatus for obtaining a video signal from a position proximate an eye level of a person viewing a display, the apparatus comprising:
a flexible coupling means having a camera portion and a fixation portion removably secured to the display to position the camera portion alongside a screen portion of the display;
a camera; and
an attachment means to attach the camera to the camera portion such that the camera is positioned between the screen portion and the person.
